(19) United States
(12) Patent Application Publication
(10) Pub. No.: US 2024/0025447 A1
(43) Pub. Date: Jan. 25, 2024

(54) Intelligent Driving System

(71) Applicant: QINGDAO WAYTOUS INC., Qingdao, Shandong (CN)

(72) Inventors: Feiyue WANG, Qingdao, Shandong (CN); Long CHEN, Qingdao, Shandong (CN); Dongpu CAO, Qingdao, Shandong (CN); Bin TIAN, Qingdao, Shandong (CN); Chen SUN, Qingdao, Shandong (CN)

(21) Appl. No.: 18/035,639

(22) PCT Filed: Sep. 24, 2020
(86) PCT No.: PCT/CN2020/117297

§ 371 Date: May 5, 2023

(30) Foreign Application Priority Data
Aug. 28, 2020 (CN) CN202010887066.2

(51) Int. Cl. B60W 60/00; B60W 40/04; B60W 40/08

(52) U.S. Cl. CPC B60W 60/0015; B60W 40/04; B60W 40/08; B60W 2420/42; B60W 2420/52; B60W 2554/406; B60W 2556/35; B60W 2556/40; B60W 2556/45

(57) ABSTRACT

An intelligent driving system (10). A vehicle-mounted subsystem (100), a road subsystem (200), and a platform subsystem (300) are provided, wherein traffic information of each road section is acquired in real time by using the road subsystem (200), and traveling paths of vehicles in each road section are obtained according to the traffic information; the platform subsystem (300) comprehensively obtains, according to the traffic information of each road section, traffic information of the entire administrative area, and the optimal traveling path; and the vehicle-mounted subsystem (100) provides a traveling path on the basis of the road subsystem (200) and the platform subsystem (300), controls an operation state of the current vehicle in view of a traveling state of itself, and performs traveling path planning according to actual road conditions of each road section, thereby improving the accuracy of traveling path planning and the safety of automatic driving.

### TECHNICAL FIELD

This application relates to assisted driving or automatic driving technology, and specifically relates to an intelligent driving system.

### BACKGROUND TECHNIQUE

As an active safety technology, automatic driving and driver assistance technology can effectively improve the safety of vehicles while driving, and obtaining driving paths plays an important role in the automatic driving system.

At present, most of the ways to obtain driving routes are route planning based on maps. One is to perceive road conditions and decide driving routes through the perception system of the bicycle. In this way, the perception system must be accurate enough to ensure the formation of safety. Such a perception system not only the cost is very high, and the security reliability of the system is not high. The other is to plan the driving route through the intelligently networked cloud control center. Although this method can be planned uniformly through the cloud control center, it can only plan for the automatic driving vehicles in the network, and for the automatic driving vehicles outside the network. The driving car cannot plan the route, and the cloud control center only plans the route through the static map, and cannot know the actual road conditions on the road surface. Therefore, the real-time performance and accuracy are not high.

### SUMMARY OF THE INVENTION

In order to solve the above-mentioned technical problems, the embodiment of the present application provides an intelligent driving system. By setting up the vehicle subsystem, the road subsystem, and the platform subsystem, the road subsystem can be used to obtain the traffic information of each road section in real time and obtain The driving path of vehicles in each road section, the platform subsystem obtains the traffic information and the optimal driving path of the entire jurisdiction based on the traffic information of each road section, the vehicle subsystem gives the driving path according to the road subsystem and platform subsystem, and combines its own driving The state controls the current running state of the vehicle, and plans the driving path according to the actual road conditions of each road section, thereby improving the planning accuracy of the driving path and the safety of automatic driving.

The present application provides an intelligent driving system, including: an on-board subsystem, set on the vehicle, and used to control the running state of the current vehicle according to the driving path of the current vehicle; wherein, the running state includes the current vehicle The state of the steering wheel and the state of the throttle; the road subsystem, which is set on the road and communicated with the vehicle subsystem, is used to obtain the traffic information of each road section and obtain the driving path of the vehicle according to the traffic information; and the platform subsystem, The platform subsystem is communicatively connected with the vehicle subsystem and the road subsystem, and is used to synthesize the traffic information of each road section to assist the driving of the vehicle.

In one embodiment, the on-board subsystem includes: an automatic driving module, used to control the automatic running state of the current vehicle; a communication module connected to the automatic driving module, used to transmit data with the outside; The communication module and the vehicle storage module connected to the automatic driving module are used to store data.

In one embodiment, the automatic driving module includes: a sensing unit, configured to obtain surrounding information of the current vehicle; an information fusion unit connected to the sensing unit, configured to fuse the surrounding information of the current vehicle to obtain The real-time external information of the current vehicle; the vehicle planning unit connected with the information fusion unit, used to plan the instant path of the current vehicle according to the real-time external information; and the vehicle execution unit connected with the vehicle planning unit, used to control the current running state of the vehicle according to the instant route and the driving route.

In an embodiment, the on-board subsystem further includes: an on-board state detection module connected to the communication module and the automatic driving module, for detecting the current function state of the vehicle.

In one embodiment, the on-vehicle state detection module includes: a driver detection unit, used to detect the driver state; a vehicle system detection unit, used to detect the functions of each module of the on-board subsystem; a driving event detection unit, for detecting driving events on the driving path; and a communication function detection unit for detecting the state of communication between the on-board subsystem and the outside.

In one embodiment, the road subsystem includes: a traffic information acquisition module, used to acquire traffic information in real time; a path planning module connected to the traffic information acquisition module, used to obtain the driving route of the vehicle according to the traffic information; and an area detection module connected to the traffic information acquisition module and the path planning module, for detecting the functional state of the road subsystem in each area section.

In an embodiment, the traffic information acquisition module includes an image acquisition device and a laser radar.

In one embodiment, the traffic information includes static information and dynamic information, wherein the static information includes road map information, and the dynamic information includes road traffic flow information.

In an embodiment, the road subsystem further includes: a communication broadcast module connected to the area detection module, for transmitting information and data to the outside.

In an embodiment, the road subsystem further includes: a road storage module connected to the traffic information acquisition module, the route planning module, and the area detection module, for storing data. In one embodiment, the platform subsystem includes: a network module, configured to obtain data information of the road subsystem and the vehicle subsystem; a data fusion module connected to the network module, configured to integrate the traffic information of each road section is fused to obtain global traffic information; and a platform storage module connected to the network module and the data fusion module is used for storing data.

In one embodiment, the intelligent driving system further includes: a training subsystem communicated with the platform subsystem, the road subsystem, and the vehicle subsystem, for The data of the road subsystem and the vehicle subsystem train and update the models and parameters of the platform subsystem, the road subsystem and the vehicle subsystem.

The embodiment of the present application provides an intelligent driving system. By setting up the vehicle subsystem, the road subsystem, and the platform subsystem, the road subsystem can be used to obtain the traffic information of each road section in real time and obtain the driving route of each road section according to the traffic information, the platform subsystem comprehensively obtains the traffic information and the optimal driving route of the entire jurisdiction according to the traffic information of each road section, and the vehicle-mounted subsystem gives the driving route according to the road subsystem and the platform subsystem, and controls the operation of the current vehicle in combination with its own driving state According to the actual road conditions of each road section, the driving path is planned, thereby improving the planning accuracy of the driving path and the safety of automatic driving.

### DESCRIPTION OF DRAWINGS

The above and other objects, features and advantages of the present application will become more apparent through a more detailed description of the embodiment of the present application in conjunction with the accompanying drawings. The accompanying drawings are used to provide a further understanding of the embodiment of the present application, and constitute a part of the specification, and are used together with the embodiment of the present application to explain the present application, and do not constitute limitations to the present application. In the drawings, the same reference numerals generally represent the same components or steps.

FIG. 1 is a schematic structural diagram of an intelligent driving system provided by an exemplary embodiment of the present application.

FIG. 2 is a schematic structural diagram of a Vehicle-mounted subsystem subsystem provided by an exemplary embodiment of the present application.

FIG. 3 is a schematic structural diagram of a road subsystem provided by an exemplary embodiment of the present application.

FIG. 4 is a schematic structural diagram of a platform subsystem provided by an exemplary embodiment of the present application.

FIG. 5 is a structural diagram of an electronic equipment provided by an exemplary embodiment of the present application.

### DETAILED DESCRIPTION

Hereinafter, exemplary embodiment according to the present application will be described in detail with reference to the accompanying drawings. Apparently, the described embodiment are only some of the embodiment of the present application, rather than all the embodiment of the present application. It should be understood that the present application is not limited by the exemplary embodiment described here.

### Application Overview

This application can be applied to any technical field using automatic driving or assisted driving. For example, the embodiment of the present application can be applied to vehicles with automatic driving or assisted driving functions. During the driving process of the vehicle, there may be unexpected events such as the sudden change of the driving lane of the own vehicle or the sudden change of driving lanes of other vehicles. lead to traffic accidents, and the automatic driving or assisted driving functions are used to avoid similar traffic accidents or minimize the severity of accidents when they occur. However, the realization of automatic driving or assisted driving functions needs to be based on the planning of the vehicle's driving path, that is, the realization of automatic driving or assisted driving functions is based on determining the driving path of the vehicle, so as to determine whether the own vehicle is safe on the future driving path. hidden dangers (that is, whether there is a possibility of traffic accidents), and then take corresponding measures according to the occurrence status and probability of the safety hazards, such as forward collision warning, adaptive cruise control, automatic emergency braking, etc.

Usually, the realization of automatic driving or assisted driving is to plan a fixed driving route based on the map. For example, based on the high-definition map provided by the third party, the driving route is planned before driving, and the vehicle travels according to the driving route. However, since the high-definition maps provided by third parties are usually static maps, that is to say, the high-definition maps will not change in a short period of time. It will not be displayed, which will obviously lead to the fact that the driving path of automatic driving or assisted driving may not be optimal, or even unrealizable (for example, temporary road closures, etc. make the planned driving path impassable). Moreover, when driving on a planned driving route, the vehicle's own perception system is usually used to obtain the surrounding road condition information and proceed. In order to ensure the safety of the driving process, it is necessary to install sensors, radars and or cameras and other sensing devices, but even so, the vehicle still has a certain viewing angle, that is, there are certain safety hazards, and these sensing devices will inevitably lead to an increase in the cost of the vehicle, and multiple sensing devices are multiple failure points, namely There is a greater risk of failure of the vehicle.

Aiming at the above-mentioned technical problems, the basic concept of this application is to propose an intelligent driving system. By setting up the vehicle subsystem, the road subsystem, and the platform subsystem, the road subsystem can be used to obtain the traffic information of each road section in real time, and obtain the information based on the traffic information. The driving path of vehicles in each road section, the platform subsystem obtains the traffic information and the optimal driving path of the entire jurisdiction based on the traffic information of each road section, the vehicle-mounted subsystem gives the driving path according to the road subsystem and platform subsystem, and combines its own driving The state controls the current running state of the vehicle, and plans the driving path according to the actual road conditions of each road section, thereby improving the planning accuracy of the driving path and the safety of automatic driving.

After introducing the basic principles of the application, various non-limiting embodiment of the application will be described in detail below with reference to the accompanying drawings.

### Example System

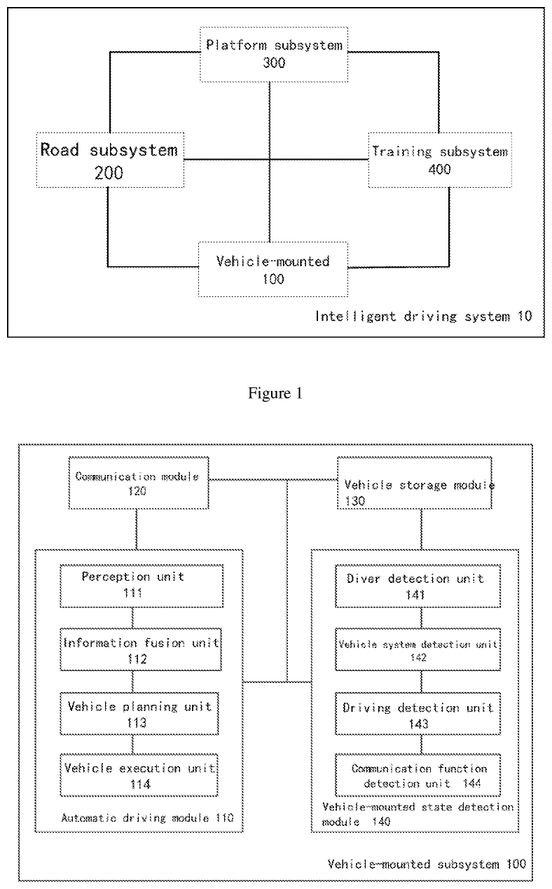

FIG. 1 is a schematic structural diagram of an intelligent driving system provided by an exemplary embodiment of the present application. As shown in FIG. 1, the intelligent driving system 10 includes a vehicle-mounted subsystem 100, a road subsystem 200 and a platform subsystem 300, and a communication connection between the vehicle-mounted subsystem 100, the road subsystem 200 and the platform subsystem 300; wherein, the vehicle-mounted subsystem 100 is set on the vehicle, and is used to control the running state of the current vehicle according to the driving path of the current vehicle, wherein the running state includes comprehensive vehicle information on the CAN bus of the current vehicle, specifically, it may include steering wheel state, accelerator state and vehicle power (when the current vehicle includes the driver, it can also include the driver's state), that is, the running state includes information such as the running direction state and the speed state of the current vehicle; the road subsystem 200 is set on the road and is used to obtain various The traffic information of the road section and the driving route of the vehicle are obtained according to the traffic information. At the same time, the traffic information obtained by the road subsystem 200 can also maintain a real-time road map, that is, the road subsystem 200 is used to obtain the traffic information of each road section in real time and according to the traffic information in the traffic information and The road map is adjusted in different places to realize the real-time update of the road map and ensure the accuracy of the road map; the platform subsystem 300 can be set on a large server such as a cloud server, and is used to synthesize traffic information of each road section to assist vehicles driving. Since automatic driving is mainly realized through the vehicle's own perception system alone or through intelligent networking, the vehicle's own perception system includes multiple cameras and radars (such as millimeter wave radar or Lidar, etc.) and other equipment to know the situation around the car body. In order to realize automatic driving and avoid emergencies, the number of cameras and radars is usually very large, which will increase the cost of the vehicle, and in order to deal with emergencies, It is necessary to know the surrounding situation in real time, which requires the perception system to analyze and process the surrounding situation in real time, that is, a chip with a large amount of calculation, calculation speed and storage capacity is required, which will obviously further increase the cost of the vehicle and difficulty; at the same time, due to cost considerations, redundant settings will not be made for each hardware device or software device. However, each device is a hidden point of failure, and multiple sensing devices from a single perspective cannot effectively improve The accuracy of the system still lacks guarantee for the safety of autonomous driving. For the way of intelligent networking, it can usually only plan the driving path for the automatic driving vehicles in the intelligent networking, and due to the existence of many non-intelligent networked automatic driving vehicles, other artificial driving vehicles and other traffic participants, it will lead to intelligent The difficulty of networking increases and the reliability decreases, and since intelligent networking is usually based on static maps provided by third parties as the main basis for driving route planning, this obviously cannot completely avoid emergencies.

In order to solve the above problems, the embodiment of the present application provides an intelligent driving system. By setting the vehicle-mounted subsystem 100 at the vehicle-mounted end, the vehicle-mounted subsystem 100 controls the current running state of the vehicle according to the planned driving route, and the vehicle-mounted subsystem 100. The system 100 only needs a small number of cameras, radars and other equipment to realize basic perception functions to assist driving, such as high-speed car following and road keeping and other auxiliary functions, which can greatly reduce the cost of a single vehicle; traffic information, wherein the traffic information includes the road conditions of the current vehicle, according to the traffic information of the current vehicle and the road segment where the current vehicle is located, the road subsystem 200 can plan the driving path of the current vehicle; and the platform subsystem 300 will be set to The traffic information of each road segment acquired by the road subsystem 200 is fused to obtain the traffic information in the jurisdiction, and according to the traffic information in the jurisdiction, the optimal driving route can be comprehensively given to assist the vehicle in driving. When the optimal driving route and the road subsystem When the driving routes planned by 200 are different, the current vehicle can be assisted in driving, thereby improving the current vehicle to drive on the optimal route, and the road subsystem 200 can ensure the driving safety of the current vehicle.

The intelligent driving system provided by the embodiment of the present application, by setting the vehicle-mounted subsystem, the road subsystem, and the platform subsystem, uses the road subsystem to obtain the traffic information of each road section in real time, and obtains the driving path of each road section according to the traffic information, and the platform subsystem The system comprehensively obtains the traffic information and the optimal driving route of the entire jurisdiction according to the traffic information of each road section. The vehicle-mounted subsystem gives the driving route according to the road subsystem and the platform subsystem, and controls the current running state of the vehicle in combination with its own driving state. The actual road conditions of each road section are used to plan the driving path, thereby improving the planning accuracy of the driving path and the safety of automatic driving.

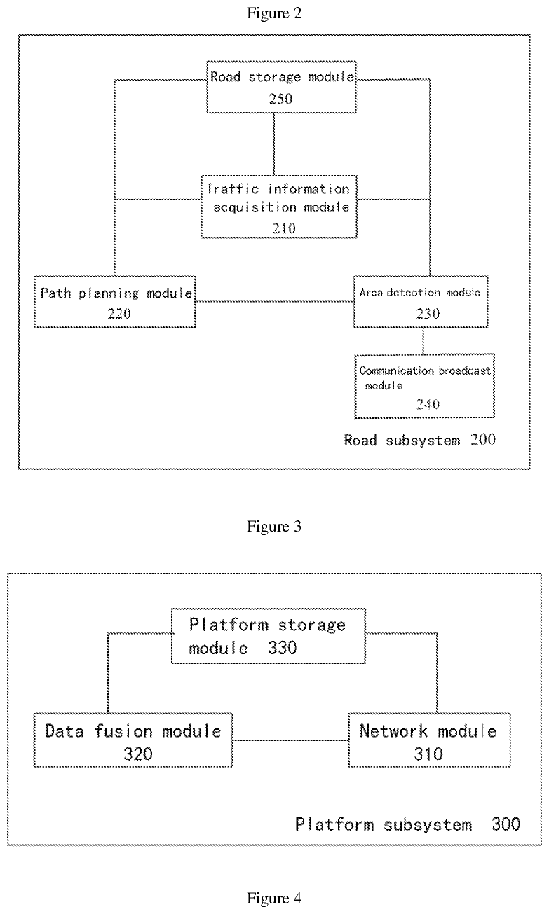

FIG. 2 is a schematic structural diagram of an vehicle-mounted subsystem provided by an exemplary embodiment of the present application. As shown in FIG. 2, the vehicle-mounted subsystem 100 may include: an automatic driving module 110, which is used to control the automatic running state of the current vehicle; a communication module 120 connected to the automatic driving module 110, which is used to transmit data with the outside. The vehicle storage module 130 connected to the automatic driving module 110 is used for storing data. The automatic driving module 110 actually controls the current vehicle, that is, the automatic driving module 110 is used to control the accelerator opening, direction, brake and other signals of the current vehicle; the communication module 120 is used for data or signal transmission with the outside, through which the communication module 120 can The driving route planned by the road subsystem 200 is transmitted to the automatic driving module 110, and the automatic driving module 110 controls the driving of the current vehicle according to the driving route; the vehicle storage module 130 can store and retrieve the data in the current driving process of the vehicle, For example, the planned driving route can be stored in the vehicle storage module 130, and the automatic driving module 110 can directly read the driving route and control the driving of the current vehicle. All are stored in the vehicle storage module 130 to facilitate subsequent viewing and recall.

In one embodiment, as shown in FIG. 2, the automatic driving module 110 may include: a perception unit 111 for obtaining surrounding information of the current vehicle; an information fusion unit 112 connected with the perception unit 111 for integrating The information fusion obtains the real-time external information of the current vehicle; the vehicle planning unit 113 connected with the information fusion unit 112 is used to plan the instant path of the current vehicle according to the real-time external information; and the vehicle execution unit 114 connected with the vehicle planning unit 113 is used for According to the real-time route and driving route, control the running state of the current vehicle. The perception unit 111 can be a small number of cameras and radars arranged around the vehicle body to obtain the basic state of the vehicle during driving, such as whether there are obstacles in front of the vehicle; information synthesis to obtain the external information of the current vehicle; the vehicle planning unit 113 plans the instant path of the current vehicle according to the obtained external information, that is, the driving strategy of the current vehicle at the current moment, for example, when there is an obstacle ahead of the driving path, it can reduce Slow speed to avoid traffic accidents; the vehicle execution unit 114 controls the running state of the current vehicle according to the planned driving route and the real-time route, so as to ensure that the current vehicle is driving on the optimal driving route while ensuring its driving safety.

In an embodiment, as shown in FIG. 2, the vehicle-mounted subsystem 100 may further include: an vehicle-mounted state detection module 140 connected to the communication module 120 and the automatic driving module 110 for detecting the current function state of the vehicle. In a further embodiment, as shown in FIG. 2, the vehicle state detection module 140 may include: a driver detection unit 141, which is used to detect the driver state; a vehicle system detection unit 142, which is used to detect the status of each module of the vehicle subsystem. function; the driving detection unit 143 is used to detect the driving event on the driving path; and the communication function detection unit 144 is used to detect the communication status between the vehicle subsystem and the outside. The driver detection unit 141 can detect the state of the driver to remind the driver to take over manually in an abnormal or emergency state, so as to ensure driving safety. The way to detect the state of the driver can be to interact with the driver to confirm; The vehicle system detection unit 142 can detect the functions of the various modules of the vehicle-mounted subsystem 200, and when one or more of the modules function abnormally, it will remind the driver and record the abnormal event; the driving detection unit 143 can detect the driving event on the driving path, The specific detection method can be learned by the vehicle's sensing device, or it can be learned by other vehicles or external devices and transmitted to the current vehicle through broadcasting. The driving detection unit 143 can obtain the driving event when detecting the driving event. The dynamic information of the area within a certain period of time (for example, one hour) before and after the event occurs, thereby forming a system log, which provides data support for the planning of subsequent driving routes, and can store the system log, which can be stored during idle time (such as charging or idling). time) upload the system log to the data center of the system, and improve data support for the subsequent development, improvement and verification of automatic driving functions; the communication function detection unit 144 can detect the communication status between the vehicle-mounted subsystem 100 and the outside, and the specific detection method can be It is to confirm whether the current driving route and current position of the vehicle can be covered by the road subsystem 200 through GNSS positioning, and whether it can communicate with the platform subsystem 300 normally. The current state of the current vehicle can be known through each unit module of the on-board state detection module 140, so as to select a driving mode that is more suitable for the current state. For example, when a certain functional module is abnormal and does not affect driving, the information level of the functional module can be reduced, to avoid safety accidents caused by the abnormal information of the functional module, and for example, when a certain function of the system is abnormal and affects driving, it can be switched to manual mode or failure mode, etc.

FIG. 3 is a schematic structural diagram of a road subsystem provided by an exemplary embodiment of the present application. As shown in FIG. 3, the road subsystem 200 may include: a traffic information acquisition module 210 for acquiring traffic information in real time; a path planning module 220 connected to the traffic information acquisition module 210 for obtaining the driving path of the vehicle according to the traffic information; And the area detection module 230 connected with the traffic information acquisition module 210 and the path planning module 220 is used to detect the functional state of the road subsystem in each area section. Through the traffic information acquisition module 210, the traffic information of each road section can be obtained in real time, including road sections that need to plan a driving route. The driving route plans the driving route of the current vehicle based on the entire road section where the current vehicle is located as a whole, thereby ensuring the optimality of the driving route and planning the driving route based on real-time road conditions can ensure driving safety and reliability. The area detection module 230 can detect the functional status of the road subsystem 200 in each area road section. For example, when an abnormality is detected in a certain road section, the information level of the road section can be reduced or the information of the road section can be suspended, and the failure can be broadcast in time to avoid The impact of abnormal information on driving vehicles can be quickly repaired and maintained. In an embodiment, the timing of detection by the area detection module 230 may be timing detection (such as a fixed time every day), abnormality detection (that is, when abnormalities such as traffic accidents or constructions occur).

In an embodiment, the traffic information acquisition module 210 may include an image acquisition device or a radar. The traffic information of each road section can be collected in real time by setting image acquisition equipment (such as a camera) or radar on each road section, wherein the image acquisition equipment or radar can be set on roadside facilities such as street lamps, traffic signs or traffic lights of each road section to form The bird's-eye view angle of view taken from a high place not only efficiently utilizes the coverage area of the equipment (far-sighted distance), but also avoids the problem of viewing angle occlusion, and can take advantage of the cross-coverage of multiple equipment. When a certain equipment fails, it can be Adjacent devices obtain traffic information in the corresponding area, thereby improving the reliability of the system.

In an embodiment, the traffic information may include static information and dynamic information, wherein the static information includes road map information, and the dynamic information includes road traffic flow information. The road map information and road traffic flow information of each road section can be obtained through the traffic information acquisition module 210, so as to avoid traffic accidents caused by relying solely on road map information and ignoring emergencies. Among them, the static information may be 3D high-precision map information, and the dynamic information may be 2D regional dynamic map information. Through the static information and dynamic information, the traffic information of each

In an embodiment, as shown in FIG. 3, the road subsystem 200 may further include: a communication broadcast module 240 connected to the area detection module 230 for transmitting information and data to the outside. By setting the communication broadcast module 240, the real-time traffic information of each road section can be transmitted to the outside, such as the platform subsystem 300, the vehicle subsystem 100, etc., and the traffic information such as traffic events can also be transmitted to the data center of the system for storage. Intelligent driving provides data support.

In an embodiment, as shown in FIG. 3, the road subsystem 200 may further include: a road storage module 250 connected to the traffic information acquisition module 210, the route planning module 220, and the area detection module 230 for storing data. By setting the road storage module 250, the traffic information data of each road section can be stored and retrieved, so as to facilitate subsequent viewing and retrieval.

FIG. 4 is a schematic structural diagram of a platform subsystem provided by an exemplary embodiment of the present application. As shown in FIG. 4, the platform subsystem 300 may include: a network module 310 for obtaining data information of the road subsystem 200 and the vehicle-mounted subsystem 100; a data fusion module 320 connected to the network module 310 for combining the traffic information is fused to obtain global traffic information; and the platform storage module 330 connected with the network module 310 and the data fusion module 320 is used for storing data. The platform subsystem 300 can be set on a large server such as a cloud server, and the platform subsystem 300 can communicate with the road subsystem 200 and the vehicle subsystem 100, and obtain the data of the road subsystem 200 and the vehicle subsystem 100 through the network module 310 information, wherein the platform subsystem 300 can communicate with the road subsystem 200 and the vehicle subsystem 100 through a communication client. equipment and resource platforms, including but not limited to mobile phones, network information platforms and Internet-connected traffic control equipment. By setting the communication client, the planned driving route can be obtained as long as the device of the client is loaded. For example, the communication client can be loaded on the vehicle with the automatic driving function, and the driving route planning of the vehicle can be realized, thereby improving System versatility. After the network module 310 acquires the data information of the road subsystem 200 and the vehicle subsystem 100, the data fusion module 320 fuses the traffic information of each road section to obtain the global traffic information within the jurisdiction, so as to better guide the operation of the autonomous vehicle. The platform storage module 330 can store and retrieve the global traffic information to facilitate subsequent viewing and retrieval. In an embodiment, the platform subsystem 300 can also detect the road subsystem 200 within the jurisdiction, such as the detection of working conditions and network communication capabilities, hardware device status, communication terminal status, software functions, and monitor traffic abnormalities Broadcast and data recording. Among them, the timing of detection can be time-segmented detection (such as morning, noon and evening on weekdays, morning, noon and evening on weekends and holidays, etc.), abnormality detection (that is, when abnormalities such as traffic accidents or construction occur).

In an embodiment, the intelligent driving system 10 may also include: a training subsystem 400 communicatively connected to the platform subsystem 300, the road subsystem 200, and the vehicle-mounted subsystem 100, for The data of the vehicle subsystem 100 trains and updates the models and parameters of the platform subsystem 300, the road subsystem 200, and the vehicle-mounted subsystem 100. By setting the training subsystem 400, the data of the platform subsystem 300, road subsystem 200, and vehicle subsystem 100 can be filtered and processed as training samples or a training model can be built with these data, thereby optimizing the platform subsystem 300, road subsystem 200. The model structure and parameters of the system 200 and the vehicle-mounted subsystem 100 can be updated synchronously after optimization, so as to ensure that users can obtain the latest traffic information and driving routes.

### Example Electronic Equipment

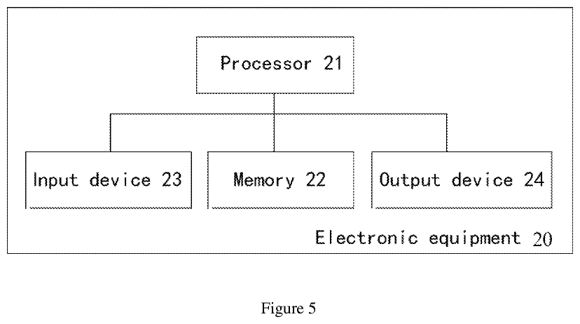

Hereinafter, an electronic device according to an embodiment of the present disclosure is described with reference to FIG. 5. The electronic device may be either or both of the first device and the second device, or a stand-alone device independent of them, and the stand-alone device may communicate with the first device and the second device to receive collected data from them input signal.

FIG. 5 illustrates a block diagram of an electronic device according to an embodiment of the disclosure. As shown in FIG. 5, the electronic equipment 20 includes one or more processors 21 and memory 22. The processor 21 may be a central processing unit (CPU) or other form of processing unit having data processing capabilities and/or instruction execution capabilities, and may control other components in the electronic equipment 20 to perform desired functions.

Memory 22 may include one or more computer program products, which may include various forms of computer-readable storage media, such as volatile memory and/or non-volatile memory. The volatile memory may include, for example, random access memory (RAM) and/or cache memory (cache). The non-volatile memory may include, for example, a read-only memory (ROM), a hard disk, a flash memory, and the like. One or more computer program instructions can be stored on the computer-readable storage medium, and the processor 21 can execute the program instructions to realize any subsystem in the intelligent driving system of the various embodiment of the present disclosure described above Or module, unit function. Various contents such as input signal, signal component, noise component, etc. may also be stored in the computer-readable storage medium.

In one example, the electronic equipment 20 may further include: an input device 23 and an output device 24, and these components are interconnected through a bus system and/or other forms of connection mechanisms (not shown).

For example, when the electronic equipment is the first device or the second device, the input device 23 may be a sensor for acquiring an input signal of motion state information. When the electronic device is a stand-alone device, the input device 23 may be a communication network connector for receiving collected input signals from the first device and the second device.

In addition, the input device 23 may also include, for example, a keyboard, a mouse, and the like. The output device 24 can output various information to the outside, including determined distance information, direction information, and the like. The output device 24 may include, for example, a display, a speaker, a printer, a communication network and its connected remote output devices, and the like.

Of course, for simplicity, only some of the components related to the present disclosure in the electronic equipment 20 are shown in FIG. 5, and components such as bus, input/output interface, etc. are omitted. In addition, according to specific application conditions, the electronic equipment 20 may also include any other suitable components.

### Example Computer Program Product and Computer Readable Storage Medium

In addition to the above-mentioned systems, embodiment of the present application may also be computer program products, which include computer program instructions that, when executed by a processor, cause the processor to perform the described function of any subsystem, module, or unit in the intelligent driving system according to various embodiment of the present application.

The computer program product can be written in any combination of one or more programming languages to execute the program codes for performing the operations of the embodiment of the present application, and the programming languages include object-oriented programming languages, such as Java, C++, etc., also includes conventional procedural programming languages, such as the “C” language or similar programming languages. The program code may execute entirely on the user's computing device, partly on the user's device, as a stand-alone software package, partly on the user's computing device and partly on a remote computing device, or entirely on the remote computing device or server to execute.

In addition, the embodiment of the present application may also be a computer-readable storage medium on which computer program instructions are stored, and when the computer program instructions are executed by a processor, the processor executes the above-mentioned “Exemplary System” section of this specification. Functions of any subsystem, module, or unit in the intelligent driving system according to various embodiment of the present application described in.

The computer readable storage medium may employ any combination of one or more readable media. The readable medium may be a readable signal medium or a readable storage medium. The readable storage medium may include, but not limited to, electronic, magnetic, optical, electromagnetic, infrared, or semiconductor systems, devices, or devices, or any combination thereof. More specific examples (non-exhaustive list) of readable storage media include: electrical connection with one or more conductors, portable disk, hard disk, random access memory (RAM), read only memory (ROM), erasable programmable read-only memory (EPROM or flash memory), optical fiber, portable compact disk read-only memory (CD-ROM), optical storage devices, magnetic storage devices, or any suitable combination of the foregoing.

The basic principles of the present application have been described above in conjunction with specific embodiment, but it should be pointed out that the advantages, advantages, effects, etc. mentioned in the application are only examples rather than limitations, and these advantages, advantages, effects, etc. Various embodiment of this application must have. In addition, the specific details disclosed above are only for the purpose of illustration and understanding, rather than limitation, and the above details do not limit the application to be implemented by using the above specific details.

The block diagrams of devices, devices, devices, and systems involved in this application are only illustrative examples and are not intended to require or imply that they must be connected, arranged, and configured in the manner shown in the block diagrams. As will be appreciated by those skilled in the art, these devices, devices, devices, systems may be connected, arranged, configured in any manner. Words such as “including”, “comprising”, “having” and the like are open-ended words meaning “including but not limited to” and may be used interchangeably therewith. As used herein, the words “or” and “and” refer to the word “and/or” and are used interchangeably therewith, unless the context clearly dictates otherwise. As used herein, the word “such as” refers to the phrase “such as but not limited to” and can be used interchangeably therewith.

It should also be pointed out that in the system of the present application, each component can be decomposed and/or reassembled. These decomposition and/or recombination should be considered equivalents of this application.

The above description of the disclosed aspects is provided to enable any person skilled in the art to make or use the present application. Various modifications to these aspects will be readily apparent to those skilled in the art, and the generic principles defined herein may be applied to other aspects without departing from the scope of the application. Thus, the present application is not intended to be limited to the aspects shown herein but is to be accorded the widest scope consistent with the principles and novel features disclosed herein.

The foregoing description has been presented for purposes of illustration and description. Furthermore, this description is not intended to limit the embodiment of the application to the forms disclosed herein. Although a number of example aspects and embodiments have been discussed above, those skilled in the art will recognize certain variations, modifications, changes, additions and sub-combinations thereof.

1. An intelligent driving system, It is characterized in that, including:
The vehicle-mounted subsystem is arranged on the vehicle and is used to control the running state of the current vehicle according to the driving path of the current vehicle; wherein the running state includes the steering wheel state and the throttle state of the current vehicle;
The road subsystem is arranged on the road and communicated with the vehicle-mounted subsystem, and is used to obtain traffic information of each road section and obtain the driving route of the vehicle according to the traffic information; and
A platform subsystem, the platform subsystem is communicatively connected with the vehicle-mounted subsystem and the road subsystem, and is used to synthesize the traffic information of each road section to assist the driving of the vehicle.

2. The intelligent driving system according to claim 1, It is characterized in that, the vehicle-mounted subsystem includes:
an automatic driving module, configured to control the automatic running state of the current vehicle;
A communication module connected to the automatic driving module, used to transmit data with the outside; and
The vehicle storage module connected with the communication module and the automatic driving module is used for storing data.

3. The intelligent driving system according to claim 2, It is characterized in that, the automatic driving module includes:
a perception unit, configured to acquire surrounding information of the current vehicle;
An information fusion unit connected to the perception unit, used to fuse the surrounding information of the current vehicle to obtain the real-time external information of the current vehicle;
a vehicle planning unit connected to the information fusion unit, configured to plan the real-time path of the current vehicle according to the real-time external information; and
The vehicle execution unit connected with the vehicle planning unit is configured to control the current running state of the vehicle according to the instant route and the driving route.

4. The intelligent driving system according to claim 2, It is characterized in that, the vehicle-mounted subsystem also includes:
The on-vehicle state detection module connected with the communication module and the automatic driving module is used to detect the function state of the current vehicle.

5. The intelligent driving system according to claim 4, It is characterized in that, the vehicle state detection module includes:
The driver detection unit is used to detect the state of the driver;
A vehicle system detection unit, configured to detect the functions of each module of the vehicle subsystem;
a driving event detection unit, configured to detect a driving event on the driving path; and
The communication function detection unit is used to detect the communication state between the on-board subsystem and the outside.

6. The intelligent driving system according to claim 1, It is characterized in that, the road subsystem includes:
The traffic information acquisition module is used to acquire traffic information in real time;
A path planning module connected to the traffic information acquisition module, used to obtain the driving path of the vehicle according to the traffic information; and
The area detection module connected with the traffic information acquisition module and the path planning module is used to detect the functional state of the road subsystem in each area section.

7. The intelligent driving system according to claim 6, It is characterized in that, the traffic information acquisition module includes an image acquisition device and a laser radar.

8. The intelligent driving system according to claim 6, It is characterized in that, the traffic information includes static information and dynamic information, wherein the static information includes road map information, and the dynamic information includes road traffic flow information.

9. The intelligent driving system according to claim 6, It is characterized in that, the road subsystem also includes:
The communication broadcast module connected with the area detection module is used to transmit information and data to the outside.

10. The intelligent driving system according to claim 6, It is characterized in that, the road subsystem also includes:
A road storage module connected to the traffic information acquisition module, the path planning module, and the area detection module is used to store data.

11. The intelligent driving system according to claim 1, It is characterized in that, the platform subsystem includes:
A network module, configured to obtain data information of the road subsystem and the vehicle subsystem;
A data fusion module connected to the network module, configured to fuse the traffic information of each road section to obtain global traffic information; and
The platform storage module connected with the network module and the data fusion module is used for storing data.

12. The intelligent driving system according to claim 1, It is characterized in that, further including:
A training subsystem communicatively connected with the platform subsystem, the road subsystem, and the vehicle subsystem, for training and updating based on the data of the platform subsystem, the road subsystem, and the vehicle subsystem Models and parameters of the platform subsystem, the road subsystem, and the vehicle subsystem.
